(19) United States
(12) Patent Application Publication
(10) Pub. No.: US 2010/0155555 A1
(43) Pub. Date: Jun. 24, 2010

(54) Apparatus for Attaching an External Object to a Portable Computer

(76) Inventor: Alan Shih, San Jose, CA (US)

Correspondence Address: Venture Pacific Law, PC, 5201 Great America Parkway, Suite 270, Santa Clara, CA, 95054, US

(21) Appl. No.: 12/647,372

(22) Filed: Dec. 24, 2009

Related U.S. Application Data
(60) Provisional application No. 61/140,843, filed on Dec. 24, 2008.

(51) Int. Cl. F16M 13/00; G06F 1/16

(52) U.S. Cl. 248/229.2; 361/679.02

(57) ABSTRACT

An attachment device for attaching an external object to a portable computer, comprising: a first clip for coupling the portable computer to the attachment device; a second clip for coupling the external object to the attachment device; and a member for connecting the first clip and the second clip.

### CROSS REFERENCE

This application claims priority from a provisional patent application entitled “Method and Apparatus for Attaching an External Object to a Portable Computer” filed on Dec. 24, 2008 and having an Application No. 61/140,843. Said application is incorporated herein by reference.

### FIELD OF INVENTION

This invention relates to an apparatus for attaching or holding one or more objects to a portable computer and, in particular, to an apparatus for securely attaching external objects to a portable computer.

### BACKGROUND

Portable computers (e.g., laptops, net books, reading devices such as a Kindle and similar devices, personal digital assistants, GPS devices, smart phones, and other portable computers) are light weight and simple to transport to every destination. Portable computers can also be applied for the same purposes as desktop computers, providing an extremely powerful tool for users. Thus, portable computers have dramatically increased in popularity over the past decade. In terms of mobility, portable computers are the most effective option as it allows a user to access online content and work from various locations.

Due to the portable and compact nature of portable computers, many computer accessories can be connected to portable computers to further expand the capabilities of the portable computers. For instance, an external hard disk drive (“HDD”), computer mouse, a keyboard, an external CD-ROM, DVD-ROM and/or Blu-Ray drive, an external floppy drive, an external modem, or other computer accessory can be connected to a portable computer.

Computer accessories are growing steadily due to the popular demand by users. People are continually looking for add-ons and additional gadgets to attach to their portable computers either to improve their performance, make usage as uncomplicated as possible, or simply to be unique. With many corporations looking to meet this demand, there is an abundance and variety of computer accessories to be found.

With the growing popularity of portable computers and computer accessories, there is a growing need for an attachment device to securely attach computer accessories onto the portable computers.

FIG. 1 illustrates an external object connected to a portable computer. A laptop 10 is connected to an external object (e.g., a HDD) 12. The external object 10 is positioned near the laptop 10, but is otherwise not physically secured to the computer. This can cause difficulty in transporting the laptop 10 from one location to another location since the external object 12 is not physically attached to the laptop 10. The user can disconnect the external object 12 from the laptop 10 for transportation, but this may cause further complexity and difficultly. Therefore, it is desirable to provide an apparatus for attaching the external object 12 and the laptop 10 such that transportation is more convenient and easy.

In addition, since the external object 12 is merely positioned near the laptop 10, the user may accidently knock over the external object 12 or otherwise damage the external object as the user normally operates the laptop 10 (e.g., typing on the keyboard or moving a mouse). Therefore, it is desirable to provide an apparatus for securely attaching the external object 12 to the laptop 10.

### SUMMARY OF INVENTION

An object of this invention is to provide an apparatus for securely coupling an external object to a portable computer.

Another object of this invention is to provide an apparatus for reducing the possibility of damaging an external object connected to a portable computer.

Yet another object of this invention is to provide an apparatus for easily carrying an external object with a portable computer.

Briefly, an apparatus for attaching an external object to a portable computer comprises the following: a first clip for coupling the portable computer to the apparatus; a second clip for coupling the external object to the apparatus; and a member for connecting the first clip and the second clip.

An advantage of this invention is that an apparatus is provided for securely coupling an external object to a portable computer.

Another advantage of this invention is that an apparatus is provided for reducing the possibility of damaging an external object connected to a portable computer.

Yet another advantage of this invention is that an apparatus is provided for easily carrying an external object with a portable computer.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates an external object connected to a portable computer.

FIG. 2 illustrates an external object attached to a portable computer by an attachment device of the present invention, where the portable computer is in an opened state.

FIG. 3 illustrates an external object attached to a portable computer by an attachment device of the present invention, where the portable computer is in a closed state.

FIGS. 4a-4c illustrate various views of an attachment device of the present invention for attaching an external object to a portable computer.

FIG. 5 illustrates another embodiment of the present invention for an attachment device having an elongated first clip with teeth.

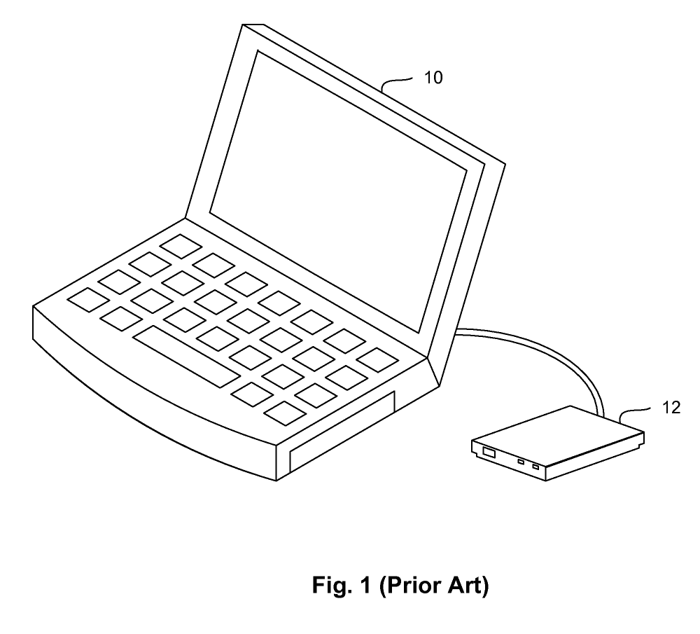

### DETAILED DESCRIPTION OF THE PREFERRED EMBODIMENTS

Generally, an attachment device is disclosed for attaching an external object (e.g., an external hard disk drive, computer mouse, a keyboard, an external CD-ROM, DVD-ROM and/or Blu-Ray drive, an external floppy drive, an external modem, or other computer accessory) to a portable computer. The attachment device can have a plurality of clips for coupling the attachment device to a portable computer and one or more external objects.

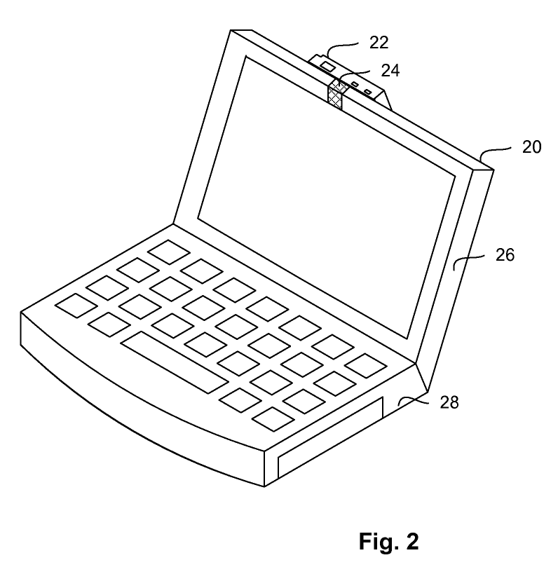

FIG. 2 illustrates an external object attached to a portable computer by an attachment device of the present invention, where the portable computer is in an opened state. A laptop 20 and an external object 22 are coupled together by an attachment device 24. The laptop 20 comprises two casings, where a first casing 26 houses a display device and a second casing 28 houses a keyboard (and/or other user input devices) and hardware components for the laptop. The laptop 20 can be in a closed state when the first casing 26 is folded onto the second casing 28. Alternatively, the laptop 20 can be in an opened state when, from a closed state, the first casing 26 is unfolded from the second casing 28.

The attachment device 24 can be attached to the laptop 20 by clipping a first clip of the attachment device 24 to the first casing 26. In addition, the attachment device 24 can be attached to the external object 22 by clipping a second clip of the attachment device 24 to the external object 22. In this manner, the laptop 20 and the external object 22 are securely coupled together via the attachment device 24.

Although the examples refer to an attachment device in relation to a laptop having a first casing and a second casing, it is to be understood that an attachment device of the present invention can be used for a variety of shapes and sizes of a portable computer and a variety of casings for the portable computer. For instance, the attachment device can be used for a tablet PC or Kindle that may have a single main casing by clipping the attachment device to the main casing.

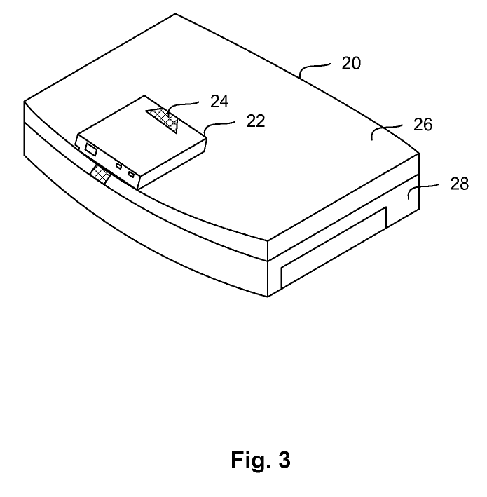

FIG. 3 illustrates an external object attached to a portable computer by an attachment device of the present invention, where the portable computer is in a closed state. Here, the laptop 20 is in a closed state, where the first casing 26 is folded on top of the second casing 28. Note, the attachment device 24 is securely attached to the first casing 26 such that when the first casing 26 is adjusted relative to the second casing 28, the attachment device 24 follows this adjustment while securely coupling the external object 22 to the first casing 26.

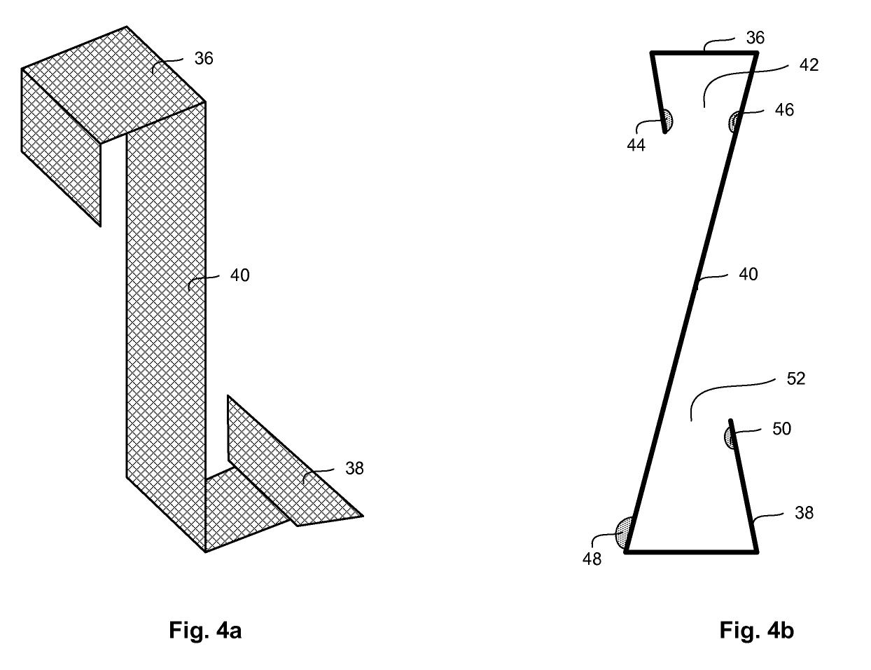

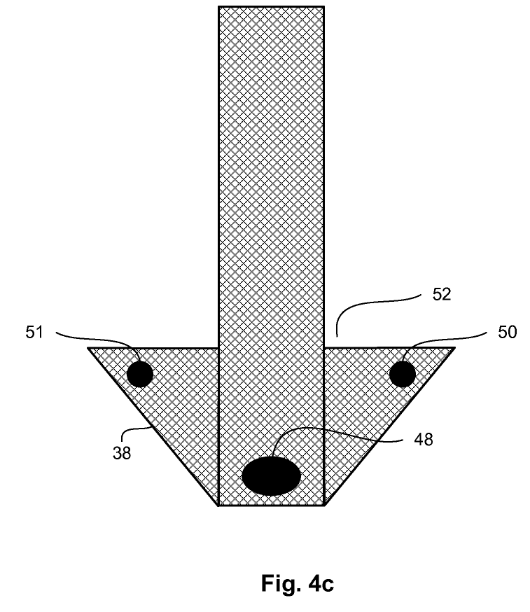

FIG. 4a illustrates a diagonal view of an attachment device of the present invention. An attachment device can comprise a first clip 36, a second clip 38, and a member 40 connecting the first clip 36 and the second clip 38 to form an “S” shape. The first clip 36 and the second clip 38 resemble hooks, where each clip can have an inner region for inserting an object. The clips 36 and 38 can be located at different ends of the member 40. The inner region of each clip may be positioned on opposite sides of the attachment device such that a portable computer can be positioned on one side of the member 40 and one or more external objects can be positioned on another side of the member 40.

The attachment device can provide a mechanical force via the clips 36 and 38 on an object within the inner region of each respective clip to couple the object to the attachment device. The clips 36 and 38 can be made with either plastic materials, sheet metal materials, or other materials, which can provide this mechanical force.

Additionally, the attachment device can have an external covering that is treated with a rubbery coating (or a nonabrasive material) to reduce scratching when placed on top of the portable computer. To reduce vibrations, the attachment device may also be constructed with shock absorbing material. Furthermore, the attachment device can be a rigid body, such that the attachment device can secure an object from detaching under the force of gravity or other incidental brushes with the object.

FIG. 4b illustrates a side view of an attachment device of the present invention. In addition to the “S” shape form of the attachment device, the attachment device may have a one or more pads to cushion a portable computer and one or more external objects. The first clip 36 may have pads 44 and 46 positioned along the inner region 42 for making contact with the portable computer. The pads 44 and 46 can be made of a nonabrasive and cushioning material to protect the finish of the portable computer and to provide traction for the first clip 36.

A pad 48 can also be positioned on the member 40 near the second clip 38 to make contact with the portable computer. The second clip 38 may also have pads 50 and 51 (not shown) on the inner region of the second clip 38 to make contact with the external object.

The attachment device can be used by inserting an external object (e.g., a HDD) into the second clip 38 of the attachment device, where the second clip 38 may have an elongated lip to secure the external object within the second inner region 52. The casing of the external object can make contact with the attachment device at three points: two points at the pads 50 and 51 and one point at the member 40 of the clip. Similarly, a portion of the portable computer is slid into the inner region 42 of the first clip 36 to secure the attachment device 34 to the portable computer.

FIG. 4c illustrates a front view of an attachment device of the present invention. The second clip 38 of the attachment device can have a shape of a trapezoid or any other shape for making contact to an external object. The shape of the second clip 38 can depend on the external object to be inserted into the clip 38.

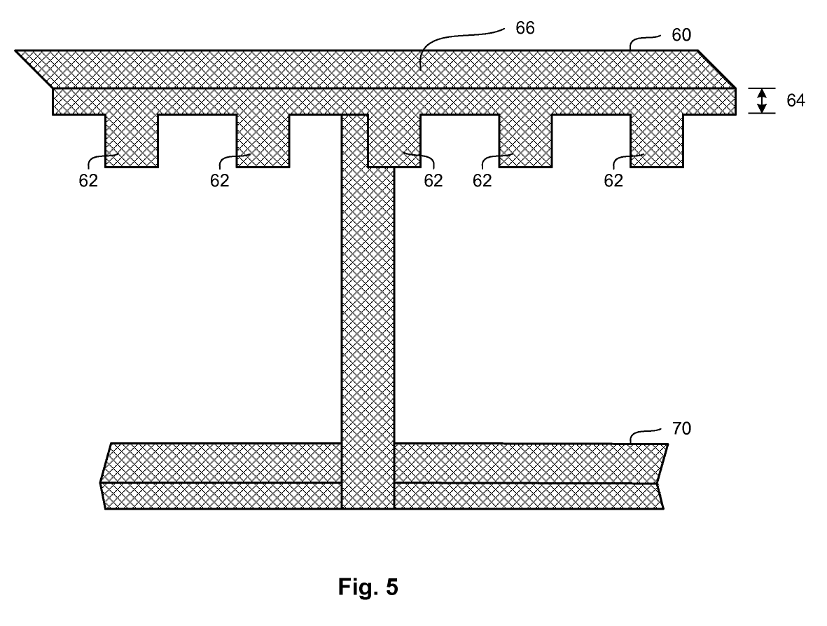

Referring to FIG. 5, in yet another embodiment of the present invention, the first clip 60 of the attachment device is an elongated tooth-like structure where there are a plurality of teeth 62 in a front portion 68 where there is sufficient space between any two teeth to accommodate a laptop having a camera head built on top of the lid of the laptop. The top portion 66 and the front portion 68 of the first clip is elongated in shape to spread the load of the weight from the second clip. The top portion 66 is also narrow since most laptop lids are thin. Each of the teeth is short in length such that it does not block the screen view (since the top edge of the lid is typically narrow); for example, a camera head may be ¼″ in width. Further, there is an optional top strip 64 on top of the teeth that is narrow in shape to provide additional support to the front portion of the first clip. This top strip 64 cannot be too wide or it would potentially obstruct the camera head (e.g. ¼″ or less).

In general, a clip of the attachment device can be of varying size to fit different portable computer screen shapes and sizes, different external object shapes and sizes, and so forth. Furthermore, a clip is not limited to a hook shape, but may also be in varying shapes to better secure an external object. For instance, a clip can be a wire basket that is attached to an end of the member of the attachment device to carry pens, pencils, or markers that may not be easily clipped to the attachment device. Alternatively, the clip can secure a power supply adapter to the portable computer by providing a long widthwise lip to securely wrap around the adapter. Overall, the clip can take many shapes for holding a variety of objects.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. An attachment device for attaching an external object to a portable computer, comprising:
a first clip for coupling the portable computer to the attachment device;
a second clip for coupling the external object to the attachment device; and
a member for connecting the first clip and the second clip.

2. The attachment device of claim 1 wherein the attachment device having a substantially S shape.

3. The attachment device of claim 1 wherein the member having a first end and a second end, wherein the first clip is connected at the first end and the second clip is connected at the second end.

4. The attachment device of claim 1 wherein the first clip has a first inner region for clipping the portable computer to the attachment device and the second clip has a second inner region for clipping the external object to the attachment device.

5. The attachment device of claim 3 wherein the first clip has a first inner region for clipping the portable computer to the attachment device and the second clip has a second inner region for clipping the external object to the attachment device, and wherein the first inner region and the second inner region are positioned on opposite sides of the member.

6. The attachment device of claim 1 wherein the first clip has one or more pads for making contact with the portable computer.

7. The attachment device of claim 1 wherein the second clip has one or more pads for making contact with the external object.

8. The attachment device of claim 5 wherein the first inner region has one or more pads for making contact with the portable computer.

9. The attachment device of claim 5 wherein the second inner region has one or more pads for making contact with the external object.

10. The attachment device of claim 1 wherein the attachment device is a rigid body.

11. The attachment device of claim 1 wherein the attachment device is coated in a scratch proof material.

12. The attachment device of claim 1 wherein the first clip, the second clip, and the member are thin, flat pieces of metal.

13. The attachment device of claim 1 wherein the second clip is customizable according to the shape and the size of the external object.

14. The attachment device of claim 1 wherein the first clip has an elongated front portion comprised of a plurality of teeth.

15. The attachment device of claim 14 wherein the front portion further comprised of a top strip that is narrow in shape.

16. The attachment device of claim 14 wherein there is a spacing between any two teeth that would allow an unobstructed view by a camera head.

17. The attachment device of claim 1 wherein the first clip further comprises an elongated top portion.

18. An attachment device for attaching an external object to a portable computer, comprising:
a first clip for coupling the portable computer to the attachment device, wherein the first clip has an elongated top portion and an elongated front portion, wherein the elongated front portion comprised of a plurality of teeth;
a second clip for coupling the external object to the attachment device; and
a member for connecting the first clip and the second clip.

19. The attachment device of claim 18 wherein the top strip is narrow in shape, and wherein there is a spacing between any two teeth that would allow an unobstructed view by a camera head.
